(19) United States
(12) Patent Application Publication
(10) Pub. No.: US 2021/0237088 A1
(43) Pub. Date: Aug. 5, 2021

(54) ENERGY EFFICIENT CONFIGURATION FOR THERMAL CYCLING DEVICE

(71) Applicant: dxImpact LLC, Renton, WA (US)

(72) Inventor: Michael Roller, Renton, WA (US)

(21) Appl. No.: 17/165,983

(22) Filed: Feb. 3, 2021

Related U.S. Application Data
(60) Provisional application No. 62/969,606, filed on Feb. 3, 2020.

(51) Int. Cl. B01L 7/00

(52) U.S. Cl. CPC B01L 7/52; B01L 2300/1894; B01L 2300/1844; B01L 2200/147; B01L 2300/0883; B01L 2300/1827

(57) ABSTRACT

A thermal cycling device has been disclosed herein. The device includes an upper housing and a lower housing for housing a plurality of components of the thermal cycling device. The plurality of components comprises at least a plurality of heat blocks, a plurality of tubes, and a heater. The heat block is a thin-walled metallic component that conforms to the contour of the corresponding tube and provides a surface for interfacing with the heater. Further, the heat block is designed to minimize thermal mass in order to reduce power required to achieve desired temperature ramp rates. Further, the heat block is designed such that it should exhibit minimal deflection when preload is applied to the corresponding tube.

### CROSS-REFERENCE TO RELATED PATENT DOCUMENTS

This patent application claims the benefit of priority of U.S. Provisional Application No. 62/969,606 entitled “Energy efficient configuration for thermal cycling device,” filed Feb. 3, 2020, which is hereby incorporated herein by reference in its entirety.

### FIELD OF THE INVENTION

The present invention disclosed herein generally relates to thermal cycling. More particularly, the present invention relates to an improvement in manufacturing DNA amplification technology by using an innovative approach to thermal cycler design. The device architecture achieves an unprecedented level of performance and capability by focusing on energy efficiency.

### BACKGROUND

Biological testing has become an important tool in detecting and monitoring diseases. In the biological testing field, thermal cycling is used to amplify nucleic acids by, for example, performing polymerase chain reaction (PCR) and other reactions. PCR in particular has become a valuable research tool with applications such as cloning, analysis of genetic expression, DNA sequencing, and drug discovery. Generally, a thermal cycler apparatus may be used for automatically performing temperature cycles in a number of test tubes which are each closed by a closure and contain a predetermined volume of a liquid reaction mixture. One such device is described in EP0236069A2. The device constructed as per EP0236069A2 is relatively bulky and requires relatively high power for operation due to its use of a solid-state heat pump, making it unsuitable for use as a modern automatic analytical device. Therefore, the purpose of the present invention is to provide a thermal cycler having minimum dimensions and requiring minimum power to operate.

### SUMMARY

It will be understood that this disclosure is not limited to the particular apparatus described herein, as there can be multiple possible embodiments of the present disclosure which are not expressly illustrated in the present disclosure. It is also to be understood that the terminology used in the description is for the purpose of describing the particular versions or embodiments only and is not intended to limit the scope of the present disclosure.

It is an objective of the present invention to provide DNA amplification technology by using an innovative approach to thermal cycler design. The device architecture achieves an improved level of performance and capability by focusing on energy efficiency. To improve energy efficiency, the device utilizes a heat block with lower thermal mass compared to the traditional machined aluminum block used in the majority of thermal cyclers on the market. Additionally, the heat block design possesses a large surface area compared to its thermal mass, allowing for rapid cooling rates using natural or forced convection cooling. The approach dramatically reduces power consumption while still performing at similar heating and cooling ramp rates as comparable machines, allowing for a compact footprint and compatibility with a host of power supply options and mobile applications.

One implementation of the device concept utilizes a highly integrated printed circuit board (PCB) assembly that contains the control electronics and individual heat blocks for each sample tube. Each heat block is made of a thin-walled metal receptacle that conforms the to the contour of each sample tube. A flange on top of the cup provides a thermal interface to the heater, which is a spiral-shaped copper trace patterned on the top layer of PCB. Sample cooling is performed with an axial cooling fan, while temperature sensing is accomplished by measuring the change in resistance of the copper PCB trace heaters, eliminating the need for discrete temperature sensors. Modern low-cost system-on-chip microcontrollers contain all of the functionality needed to accomplish the complex task of simultaneously sensing and controlling the temperatures of multiple sample tubes. The result is a compact integrated circuit board assembly that contains all of the functional systems of a thermal cycler. In this device, the temperature of each sample tube is controlled individually.

Another implementation of a thermal cycler device utilizing the thin-walled heat block concept follows a more conventional approach. The heat block holds multiple sample tubes rather than an individual heat block and heater for each sample tube as described in the previous implementation. This device also separates the heater PCB from the PCB for control electronics. The heater PCB is a flexible PCB that electrically connects to control PCB. A mechanical capture feature is added to constrain the heat block rather than relying on bonding to a rigid PCB as described in the previous device concept. Finally, this device implementation uses a single discrete temperature sensor attached to the heat block to measure sample temperature.

These and other features and advantages of the present invention will become apparent from the detailed description below, in light of the accompanying drawings.

### BRIEF DESCRIPTION OF ACCOMPANYING DRAWINGS

The foregoing summary, as well as the following detailed description of the innovation, is better understood when read in conjunction with the appended drawings. For the purpose of illustrating the innovation, exemplary constructions of the innovation are shown in the drawings. However, the innovation is not limited to the specific methods and structures disclosed herein. The description of a method step or a structure referenced by a numeral in a drawing is applicable to the description of that method step or structure shown by that same numeral in any subsequent drawing herein.

FIG. 1 exemplarily illustrates an integrated thermal cycler device, according to an embodiment of the present invention utilizing individual heat blocks for each sample tube.

FIG. 2 exemplarily illustrates a heat block and a mandrel for producing the heat block, according to an embodiment of the present invention.

FIGS. 3A-3B exemplarily illustrate representations of proposed reductions to thermal mass compared to conventional construction, according to an embodiment of the present invention.

FIGS. 4A-4B exemplarily illustrate device components, according to an embodiment of the present invention.

FIG. 5 exemplarily illustrates an exploded view of the thermal cycler device utilizing a single heat block for multiple sample tubes, according to an embodiment of the present invention.

FIG. 6 exemplarily illustrates a cross-section of interface between heat block, sample tube, heater, and device housing, according to an embodiment of the present invention.

FIG. 7 exemplarily illustrates a conductive trace design of a resistive heater for the thermal cycler device, according to an embodiment of the present invention.

FIG. 8 exemplarily illustrates a location of a temperature sensor on the heat block, according to an embodiment of the present invention.

FIG. 9 exemplarily illustrates airflow through the thermal cycler device, according to an embodiment of the present invention.

FIG. 10 exemplarily illustrates a heat block profile, according to an embodiment of the present invention.

FIG. 11 exemplarily illustrates optical access ports, according to an embodiment of the present invention.

Further areas of applicability of the present invention will become apparent from the detailed description provided hereinafter. It should be further understood that the detailed description of exemplary embodiments is intended for illustration purposes only and is, therefore, not intended to necessarily limit the scope of the invention.

### DETAILED DESCRIPTION

As used in the specification and claims, the singular forms “a”, “an”, and “the” may also include plural references. For example, the term “an article” may include a plurality of articles. Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the present invention. There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of components, which contribute to a thermal cycler device. Accordingly, the components have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the present invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the present invention.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element, or limitation. Furthermore, repeated use of the phrase “in an embodiment” does not necessarily refer to the same embodiment.

The words “comprising”, “having”, “containing”, and “including”, and other forms thereof, are intended to be equivalent in meaning and be open ended in that an item or items following any one of these words is not meant to be an exhaustive listing of such item or items or meant to be limited to only the listed item or items.

Unless stated otherwise, terms such as “first” and “second” are used to arbitrarily distinguish between the elements or entities. Thus, these terms are not necessarily intended to indicate temporal or other prioritization of such elements or priorities. While various exemplary embodiments of the disclosed apparatuses have been described below, it should be understood that they have been presented for purposes of example only, and not limitations. It is not exhaustive and does not limit the present invention to the precise form disclosed. Modifications and variations are possible in light of the below teachings or may be acquired from practicing of the present invention, without departing from the breadth or scope.

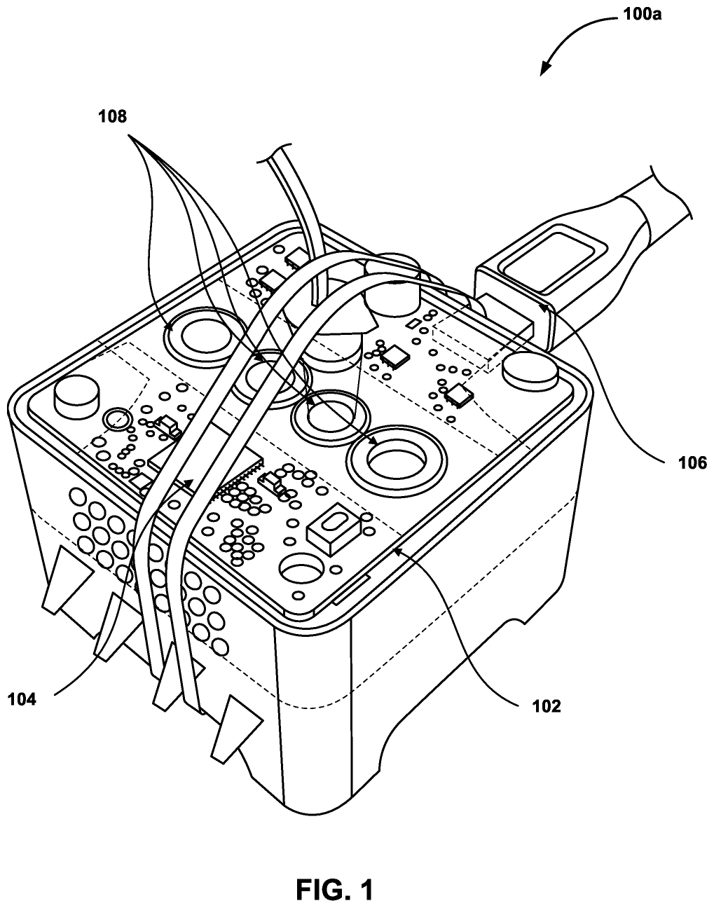

The thermal cycler device of the present invention will now be described with reference to the accompanying drawings, which should be regarded as merely illustrative without restricting the scope and ambit of the present invention. Embodiments of the present invention will now be described with reference to FIGS. 1-13.

FIG. 1 exemplarily illustrates an integrated thermal cycler device 100a, according to an embodiment of the present invention. This thermal cycler device 100a consists of an integrated circuit board 102 with a microcontroller 104, a USB power supply 106, and four heat blocks 108 (as shown in FIG. 1). Temperature sensing and a simple proportional-integral-derivative (PID) control algorithm may be performed on the microcontroller 104. The integrated device 100a may also include a cooling fan and a housing. Further, one or more rubber bands may be used to hold one or more tubes in place during operation. The thermal cycler device 100a exhibits heating and cooling ramp rates of approximately 3 degrees Celsius per second and 2 degrees Celsius per second, respectively, while using only 1.5 W maximum power consumption per sample. Additionally, the device can maintain a steady state sample temperature to within +/−0.5 degree Celsius.

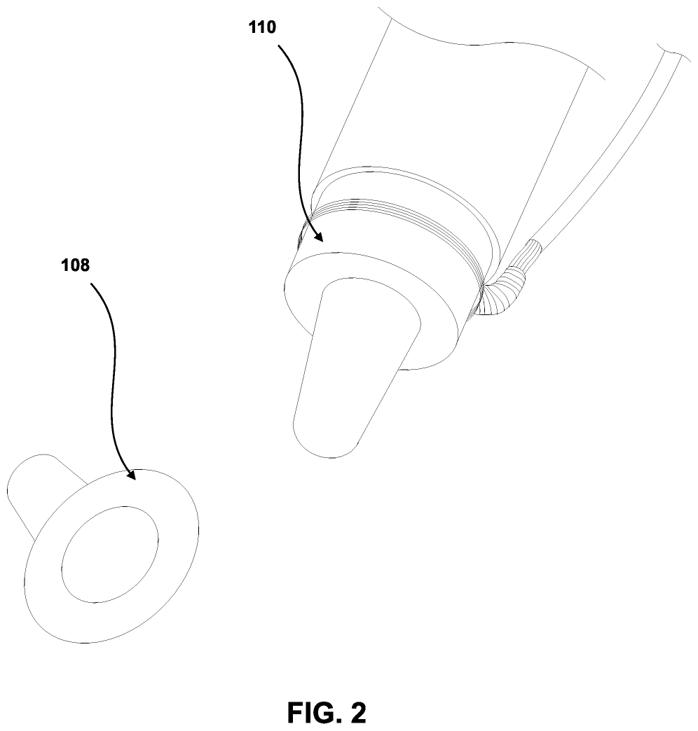

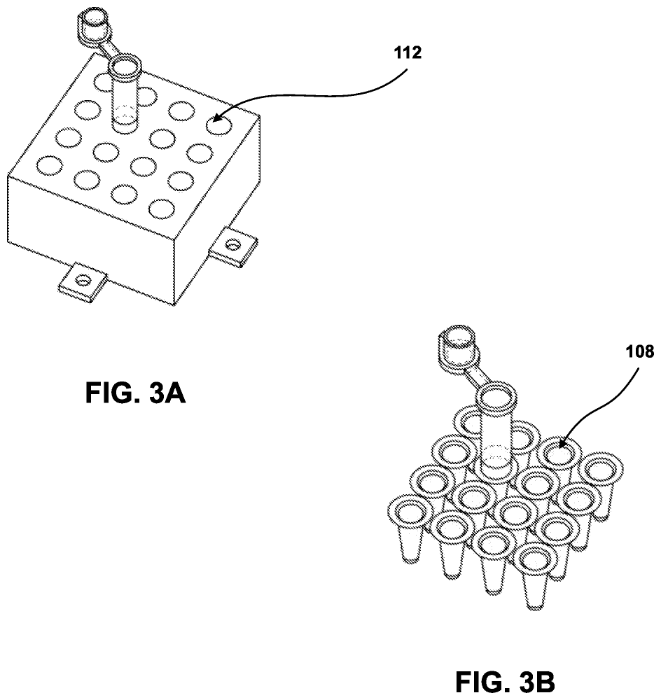

FIG. 2 exemplarily illustrates a prototype heat block 108 and a mandrel 110 for producing the heat block 108, according to an embodiment of the present invention. The heat block 108 is a thin copper receptacle that is fabricated by electroforming on the mandrel 110 such as a stainless-steel mandrel. A key component in design is the thin metal construction that is used for the heat block. Electroforming is utilized as an effective technique for producing heat blocks (such as one shown by 108) in small quantities for prototyping purposes as shown in FIG. 3. This process may be refined further in order to produce high quality and consistent prototype devices as well as production devices.

FIGS. 3A-3B exemplarily illustrate representations of proposed reductions to thermal mass, according to an embodiment of the present invention. More specifically, FIG. 3A illustrates an example of traditional aluminum heat block with machined tube wells 112. FIG. 3B illustrates an example of the corresponding version of the heat blocks utilizing the design principles proposed for a low thermal mass, formed copper heat block version corresponding to the heat blocks 108. In this example corresponding to the design topology of the thermal cycler device 100a, a separate heat block is used for each of the 16 sample tubes, in contrast to the singular heat block of FIG. 3A.

In an embodiment, the thermal mass of the heat block 108 may be reduced by using individual thin-walled copper metal receptacles instead of a solid aluminum heat block. To ensure temperature uniformity between samples, the proposed design individually senses and controls the temperature of each sample tube. Most thermal cyclers utilize a solid aluminum heat block which has been machined to provide receptacles for PCR sample tubes (FIG. 3A). These blocks possess significant thermal mass, creating uniform temperature distribution for all tube wells. However, the large thermal mass also requires considerable power consumption in order to attain reasonable temperature ramp rates. High performance high-throughput thermal cyclers typically have a thermal mass over 100 J/° C. for a 96-well heat block, resulting in over 500 W of power to achieve a 5-6° C./s ramp rate (5.21 W per well). The heat block shown in FIG. 3A, which is representative of a common machined aluminum heat block design, has a thermal mass of 17.6 J/° C. for 16 wells, which requires a theoretical minimum power of 62 W to achieve a 3.5° C./s ramp rate (3.88 W per well). The proposed heat block design 108 consists of thin copper receptacles, reducing thermal mass for 96 wells down to 5.6 J/° C. total. This represents a nearly 20× reduction in the heat block energy required. The thermal mass of the individual heat block 108 (0.058 J/° C.) is actually less than the thermal mass of a 25-microliter sample of water (0.105 J/° C.). Thus, the reduction of thermal mass in the heat block leads to the total thermal cycling mass to be dominated by the thermal mass of the sample.

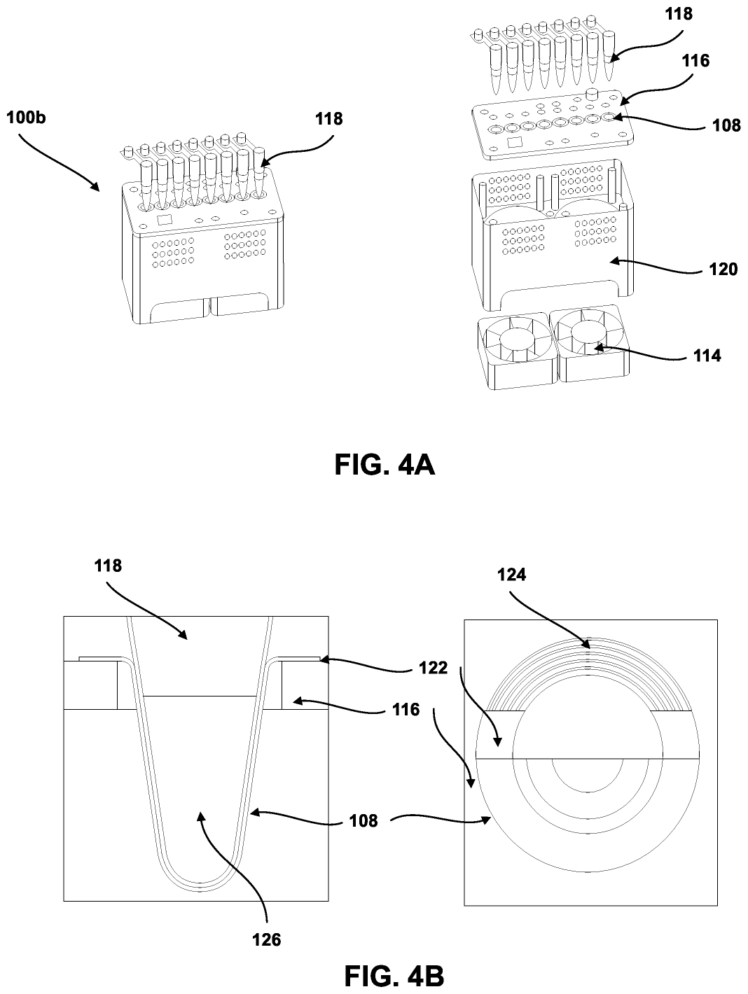

FIGS. 4A-4B exemplarily illustrate device components, according to an embodiment of the present invention. The thermal cycler device 100b can be considered equivalent to the thermal cycler device 100a in design, except that the thermal cycler device 100b has a capacity for 8 sample tubes 118 instead of 4 sample tubes (as shown in FIG. 1), and accordingly contains 8 heat blocks 108 and two cooling fans 114. FIG. 4A is a diagram that illustrates the single PCB 116 with the heat blocks 108 depicted as copper circles. The cooling fans 114 are assembled into the housing 120. A strip of eight PCR tubes 118 are shown in the copper heat block. FIG. 4B is a diagram that illustrates the core thermal design: a single copper heat block 108 as a cross section and cut-away top view. The heat block 108 is attached to the PCB 116 covering the patterned heater trace 124, shown as thin copper lines in the top view. The heat block 108 is adhered using a thermal epoxy at an interface 122. The depth of the PCR tube 118 and the sample volume 126 is shown by cross section. The sample volume 126 is a liquid reaction volume. The objective is to reduce the number of core components by combining the control electronics and heat blocks 108 on a monolithic highly integrated PCB 116 (FIG. 4A). The disclosed heat blocks 108 are made of thin metallic receptacles that conform to the contour of the PCR tube 118 and can be attached directly to the PCB 116 (FIG. 4B). A flange on top of the receptacle provides a thermal interface to the heater 124, which is a spiral-shaped copper trace patterned on the top layer of PCB 116 (FIG. 4B). The heat block 108 is bonded to the heater 124 with a thin layer of thermally conductive electrically insulating epoxy 122. The only major component not incorporated in the integrated PCB 116 is the cooling fan 114, which functions to rapidly cool the tubes 118 during cycling (FIG. 4A). Temperature sensing is accomplished by measuring the change in resistance of the copper PCB trace heater 124, thus eliminating the need for discrete temperature sensors. This reduces the device's complexity and permits temperature measurement that is closer to the sample. Although the change in heater resistance is relatively small (approximately 1-2 mΩ/° C.), changes can be measured effectively using various precision techniques, such as Kelvin sensing to increase accuracy, correlated-double-sampling to reduce noise and error, and lock-in amplification to reduce low frequency noise.

For mitigating any risk due to thermal fatigue in the circuit board caused by cycling, the PCB trace heater 124 has been designed with these concerns in mind. The PCB trace heater 124 is spiral-shaped, so that there are no sharp corners to serve as nucleation sites for thermal stress-induced cracks (FIG. 4B). Additionally, vias (electroplated holes) and solder joints in the heat block interface have been eliminated, as these features can be sources of thermal fatigue failure in circuits. To reduce the possibility of stress failures caused by differential thermal expansion, materials in the thermal interface have matching thermal expansion coefficients. Although the thermal fatigue has been addressed to the best of abilities, extensive empirical lifecycle analysis may be undertaken to validate the design.

Additionally, the thermal epoxy 122 used to bond the heat blocks 108 to the PCB heaters 124 can be patterned by existing compatible machines, such as screen printers, stencil printers, or paste dispensers.

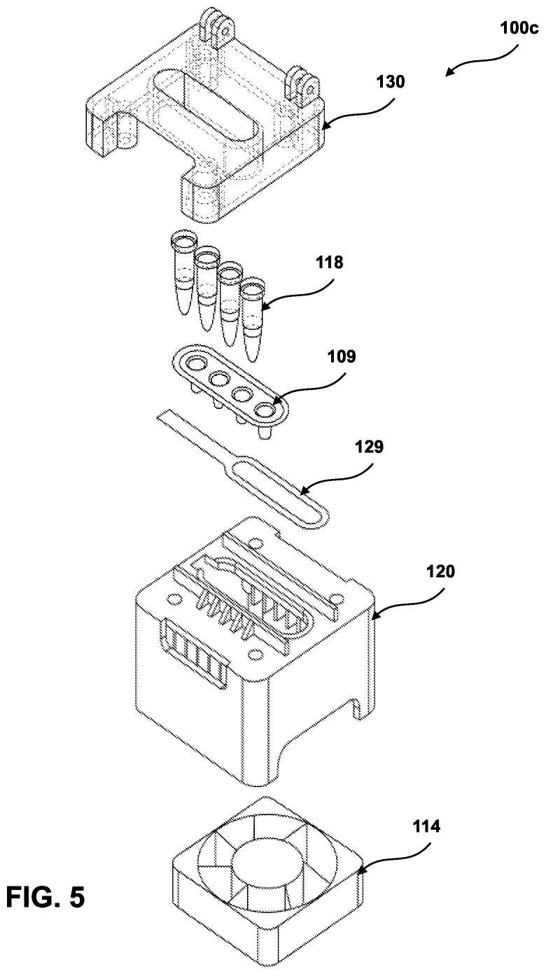

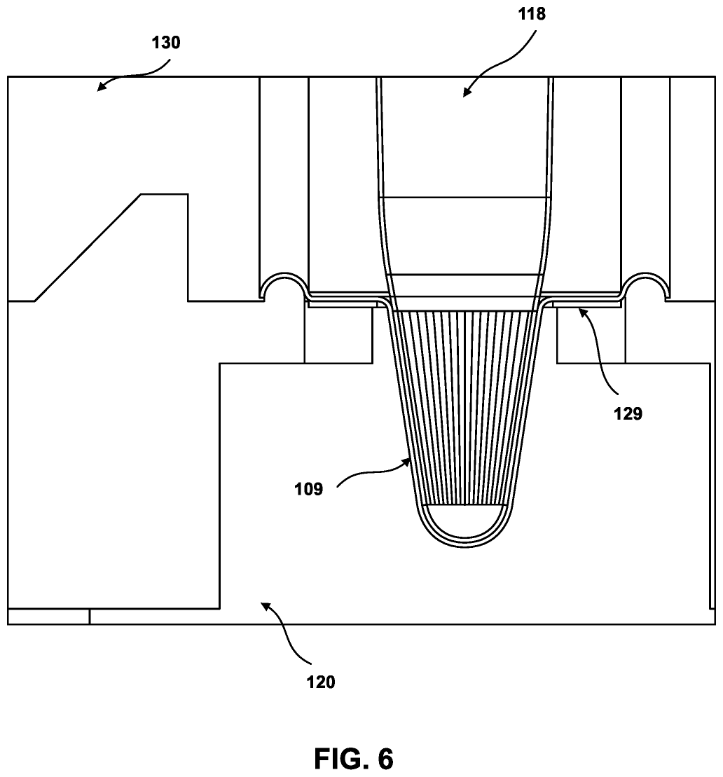

FIG. 5 exemplarily illustrates an exploded view of the thermal cycler device 100c, according to an embodiment of the present invention. The thermal cycler device 100c differs in implementation from the thermal cycler device 100a but utilizes the same innovation of a thin-walled metal heat block. This thermal cycler device 100c utilizes a heat block 109 with multiple sample wells, in contrast to the use of multiple single-sample heat blocks 108 used in the thermal cycler device 100a. The thermal cycler device 110c may include an upper housing 130, sample tubes 118, heat block 109, a heater 129, a lower housing 120, and a cooling fan 114. The design consists of a thermally conductive receptacle for one or more sample vessels (i.e., the heat block 109), the resistive electric heater 129, the cooling fan 114, the temperature sensor (shown in FIG. 8), and the rigid mounting substrate 120.

FIG. 6 exemplarily illustrates a cross-section of interface between the heat block 109, the sample tube 118, the heater 129, and the device housing 120 and 130, according to an embodiment of the present invention. The heat block 109 has been designed to minimize thermal mass in order to reduce the power required to achieve the desired temperature ramp rates. Additionally, a large surface area of the heat block is desired in order to maximize the cooling rate from the forced convection cooling. The ideal design to achieve these objectives is a thin-walled heat block (as shown by 109) that conforms to the contour of the sample tube 118, provides a surface for interfacing with a resistive electric heater, and is optionally provisioned for mechanical constraint. The heat block 109 may conform to the entire sample vessel in order to maximize the permissible sample size, or it may conform to only a portion of the sample vessel that contains sample fluid. For example, a 200 μL PCR tube may typically only contain a 25 μL sample. It is advantageous for the heat block 109 to contact only the portion of the tube 118 that contains the sample, since this will minimize thermal mass and thus improve heating and cooling rates. The heat block 109 must be fixed in position in order to create a complete thermal cycling device 100c. The heat block 109 may be bonded in place to the electric heater 129 or it may be mechanically captured and constrained by two components of the device housing (as shown in FIG. 6). The heat block 109 and its constraint method should exhibit minimal deflection when preload is applied to the sample tubes.

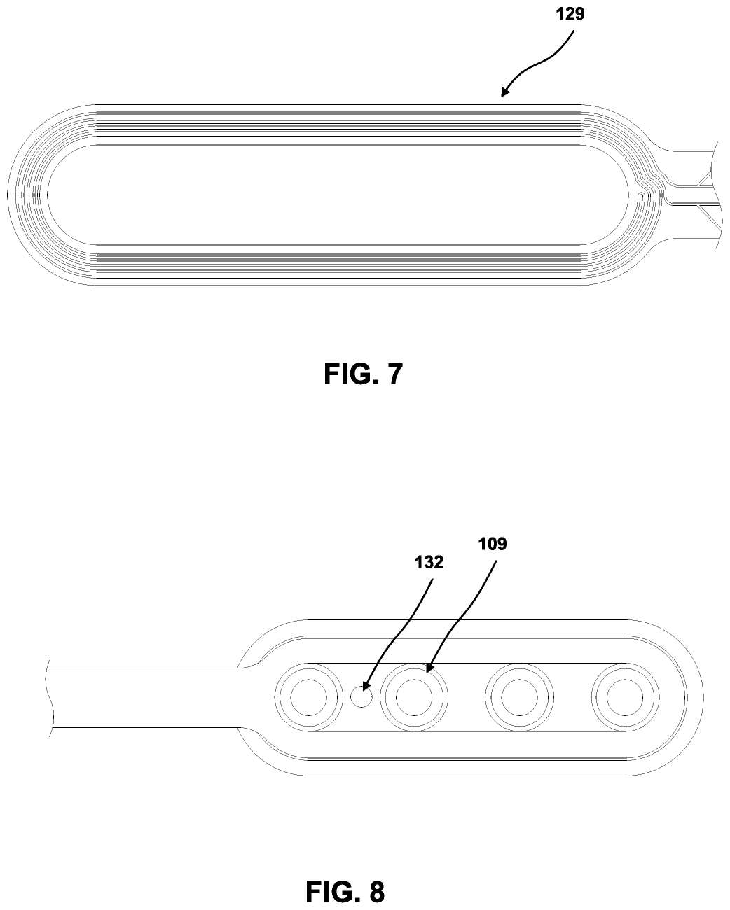

FIG. 7 exemplarily illustrates a conductive trace design of the heater 129 for the thermal cycler device 100c, according to an embodiment of the present invention. The resistive heater 129 is formed by a spiral-shaped conductive trace produced by standard printed circuit board manufacturing techniques. If the heater's circuit board substrate is sufficiently rigid, it can serve as the mounting structure for the heat block 109. To maximize heat transfer from the heater 129 to the circuit board, the traces should be printed on an outer layer of the circuit board with no solder mask present at the thermal interface. The geometry of the resistive traces should be designed to minimize or eliminate sources of thermal fatigue stress such as sharp internal corners or plated holes (vias). An example of the patterned resistive trace heater 129 has been shown in FIG. 7.

FIG. 8 exemplarily illustrates a location of the temperature sensor 132 on the heat block 109, according to an embodiment of the present invention. In one example, the temperature sensor 132 may located on the bottom of the heat block 109. The temperature sensor 132 may be attached to the heat block 109 to monitor the heat block temperature. The sensor 132 should possess minimal mass in order to quickly reach temperature equilibrium with the heat block 109. The sensor 132 should also be attached to the heat block 109 in a way that minimizes thermal resistance between the sensor 132 and the heat block 109. The sensor 132 may be placed in a location on the heat block 109 that most closely matches the average sample temperature. FIG. 8 depicts a typical sensor location. Alternatively, the resistive heater 129 may function as a temperature sensor by exploiting the temperature coefficient of resistance of the conductor (typically copper). In this approach, the long continuous trace of the heater 129 behaves as a copper RTD temperature sensor by measuring the resistance of the heater 129. When this approach is used, the heater should utilize a 4-wire connection for accurate Kelvin sensing of the heater's resistance. Such an approach will require calibration of the temperature reading. The heater 129 shown in FIG. 7 depicts a typical 4-wire connection configuration. Electrical connections to the temperature sensor should be tolerant of thermal cycling, thus electrically conductive adhesive or mechanical crimp connections are preferred to a soldered connection.

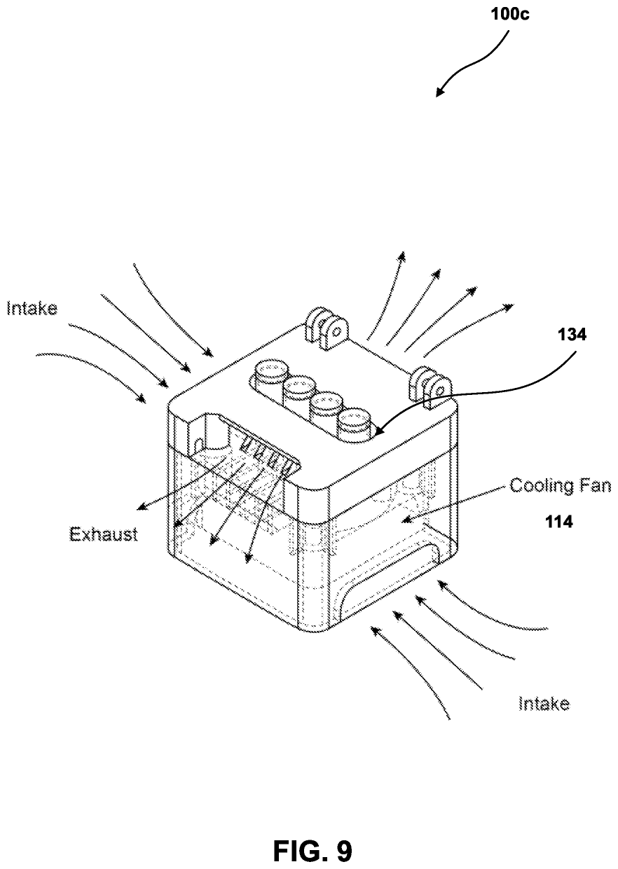

FIG. 9 exemplarily illustrates airflow through the thermal cycler device 100c, according to an embodiment of the present invention. One or more cooling fans 114 may be used for facilitating airflow through the thermal cycler device 100c. These fans 114 provide forced-air convention cooling for the thermal cycler device 100c. The fans 114 are positioned below the heat block assembly 134 and orientated so that the fan exhaust is pointed towards the bottom of the heat block 109. The device housing contains intake and exhaust vents to allow airflow through the device while the fans 114 are ON. The vents should be of sufficient size to prevent a significant pressure drop across them and should be positioned to maximize airflow across the bottom of the heat block 109. Furthermore, the vents should be positioned to minimize recirculation of the exhaust air back into the device through the intake vents as shown in FIG. 9. It may be preferred in some embodiments to omit the use of a cooling fan and rely on natural gravity convective cooling. This approach may reduce the cost and device footprint in exchange for reduced cooling ramp rates.

Manufacturing and Assembly:

The thin-walled nature of the heat block design 109 may be difficult to manufacture by traditional subtractive machining methods. Alternative manufacturing methods include electroforming or, for single-tube axisymmetric designs, progressive deep drawing. The heat block 109 may also be plated with a thin coating of another metal to prevent corrosion such as nickel or gold. The resistive electric heater 129 is bonded to the heat block 109 with a thermally conductive and electrically insulative adhesive that is designed to withstand repeated thermal cycling. The adhesive may be deposited onto either the heat block 109 or the electric heater 129 using various deposition methods including but not limited to screen printing, stencil printing, pneumatic syringe deposition, or piezoelectric jetting. The adhesive layer should be as thin as possible to maximize heat transfer between the heater 129 and the heat block 109, but not so thin as to create an electrical short between the heater 129 and the (electrically conductive) heat block 109. The patterned traces of the electric heater 129 will be facing the heat block 109 when assembled and bonded together. The temperature sensor 132 is also bonded to the heat block 109 with a thermally conductive and electrically insulative adhesive. This design and construction methodology can be considered to be scalable from a single sample up to a two-dimensional array of thousands of samples. For devices featuring a large number of samples in one or more dimensions, multiple heaters and temperature sensors as described above may be used to enable multi-zone temperature control of the heat block 109. This approach may be used to ensure temperature uniformity throughout the heat block 109 or to perform gradient temperature control throughout the heat block 109. Larger implementations such as this would also likely incorporate multiple cooling fans 114 that may or may not correlate to the multiple heating zones. In large implementations, the thin nature of the heat block 109 may require mechanical support in addition to constraint at the periphery in order to minimize deflection due to preload applied to the sample tubes.

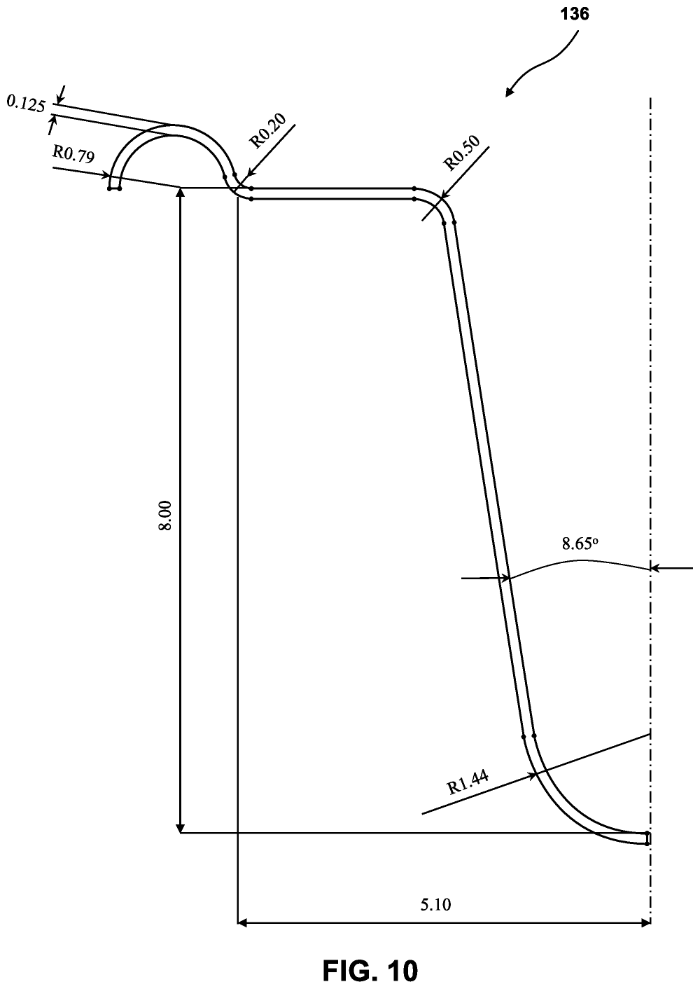

In the preferred embodiment, the heat block 109 is electroformed from copper, has a thickness of 125 um, and is plated in nickel (less than 5 um thickness). The profile of the preferred embodiment is shown in FIG. 10. FIG. 10 exemplarily illustrates the heat block profile 136. The thickness of the adhesive in the preferred embodiment is between 50 um and 150 um. In the preferred embodiment, the circuit board substrate will be as thin as possible (such as 4 mil thickness polyimide flex substrate) to minimize thermal mass of the heat block assembly. Mechanical capture features are preferred to adhesive bonding of the heat block to a rigid substrate. An exemplary dimension profile of the heat block profile 136 has been shown in FIG. 10 but should not be construed as limiting to the scope of the present invention.

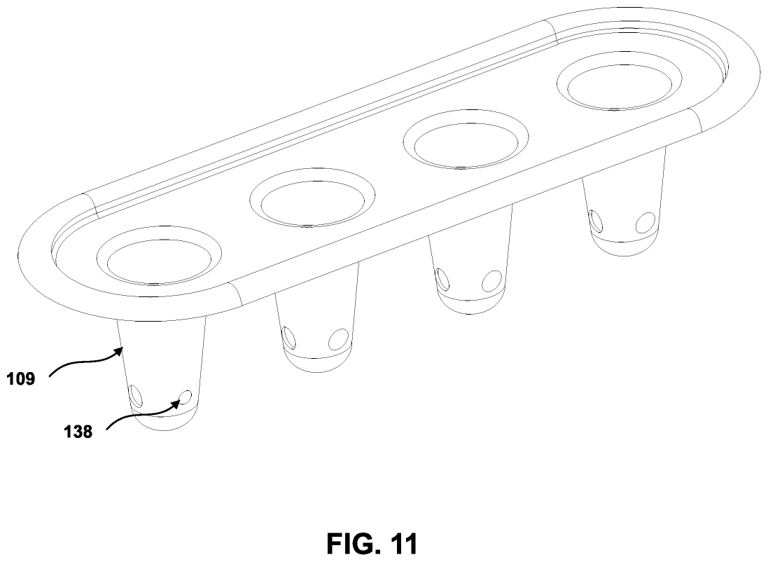

FIG. 11 exemplarily illustrates optical access ports 138 in the heat block 109, according to an embodiment of the present invention. The optical access ports 138 i.e., holes in the heat block 109 may be added to create optical access to the sample to facilitate the introduction of excitation light or the detection of fluorescence emission light from the sample. FIG. 11 shows an example of the heat block 109 with the optical access ports 138. If the heat block 109 is manufactured using electroforming, then the holes 138 may be formed during the electroforming process by incorporating non-conductive portions of the electroforming mandrel where the holes are desired. The holes 138 may also be drilled by common techniques such as mechanical drilling or laser drilling, but a support tool may be needed during the drilling process due to the thin nature of the part. The optical access ports 138 allow visibility into the reservoirs or sample tubes.

Thermocouple temperature probe—a thermocouple probe may be used for temperature sensing. In this instance, the probe may not necessarily be bonded to the heat block 109 with an adhesive, but instead it may be welded, soldered, or brazed to the heat block 109. This approach has the advantage of utilizing metal bonds with high thermal conductivity. The use of thin gauge thermocouple wire also permits a temperature sensor with low thermal mass.

Adhesive options beyond thermal epoxy—the thermal conductivity of the adhesive used to bond the heater 129 to the heat block 109 may not be critical. A thin-film acrylic adhesive transfer tape (for example: 3M 468MP) may be used instead of the thermal epoxy. Mechanical constraint of the heat block 109 should ideally be designed in such a way so as to maximize the thermal resistance of the interface. This will reduce conductive heat loss through the interface. This may be achieved by using materials with low thermal conductivity in the restraining/capturing parts and minimizing the contact area between the heat block and the restraining/capturing components.

Non-contact temperature sensing—as an alternative to direct temperature measurement using a thermally coupled temperature sensor, a non-contact infrared temperature sensor may be used. The sensor would be pointed towards the heat block 109 in a position and orientation to produce an accurate temperature reading.

Techniques consistent with the disclosure provide, among other features, the thermal cycling device 100a, 100b, or 100c. While various exemplary embodiments of the disclosed unit have been described above, it should be understood that they have been presented for purposes of example only, and not limitations. It is not exhaustive and does not limit the disclosure to the precise form disclosed. Modifications and variations are possible in light of the above teachings or may be acquired from practicing of the disclosure, without departing from the breadth or scope.

While various embodiments of the disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

What is claimed is:

1. A thermal cycling device, comprising:
a housing for a plurality of components of the thermal cycling device, wherein the plurality of components comprises at least:
one or more heat blocks,
one or more sample tubes, and
one or more heaters,
wherein each heat block is a thin-walled metallic receptacle for one or more sample tubes and conforms to the contour of the corresponding tubes and provides a surface for interfacing with the heater, and
wherein each heat block is designed to minimize thermal mass in order to reduce power required to achieve desired temperature ramp rates.

2. The thermal cycling device of claim 1, wherein each heat block is bonded in place to the heater or is mechanically captured and constrained by two components of the device.

3. The thermal cycling device of claim 2, wherein each heat block is designed such that it should exhibit minimal deflection when preload is applied to the corresponding tube.

4. The thermal cycling device of claim 2, wherein a thermal mass of each heat block is reduced by using thin-walled metallic fabrication techniques.

5. The thermal cycling device of claim 2, further comprising a printed circuit board (PCB) that constitutes one or more heaters formed by resistive traces.

6. The thermal cycling device of claim 2, wherein each heat block is bonded to the heater with a thin layer of thermally conductive electrically insulating adhesive or adhesive designed to eliminate air gaps.

7. The thermal cycling device of claim 1, wherein the heater is a PCB trace heater that is designed to mitigate risk of thermal fatigue failure in the PCB caused by thermal cycling.

8. The thermal cycling device of claim 7, wherein the heater is formed by spiral or serpentine-shaped conductive traces so that there are no sharp corners to serve as nucleation sites for stress-induced cracks.

9. The thermal cycling device of claim 7, wherein the heater includes traces that are printed on an outer layer of a PCB with no solder mask present at a thermal interface in order to maximize heat transfer from the heater to the PCB.

10. The thermal cycling device of claim 1, further comprising at least one cooling fan that is used for facilitating airflow through the thermal cycler device.

11. The thermal cycling device of claim 10, wherein the cooling fan functions to rapidly cool the sample tubes during cycling.

12. The thermal cycling device of claim 10, wherein the cooling fan provides forced-air convection cooling for the thermal cycler device, and wherein the cooling fan is positioned and orientated so that the cooling fan exhaust is pointed towards the bottom of the heat block.

13. The thermal cycling device of claim 1, further comprising a temperature sensor that is located on each heat block.

14. The thermal cycling device of claim 13, wherein the temperature sensor is attached to each heat block to monitor the heat block temperature.

15. The thermal cycling device of claim 13, wherein the temperature sensor should possess minimal mass in order to quickly reach temperature equilibrium with the corresponding heat block, and wherein the temperature sensor should also be attached to the heat block in a way that minimizes thermal resistance between the temperature sensor and the heat block.

16. The thermal cycling device of claim 13, wherein the temperature sensor is placed in a location on the heat block that represents an average sample temperature.

17. The thermal cycling device of claim 1, wherein each heat block is designed to include a plurality of optical access ports.

18. The thermal cycling device of claim 17, wherein the optical access ports are added to create optical access to a sample to facilitate an introduction of excitation light or a detection of fluorescence emission light from the sample.

19. The thermal cycling device of claim 1, further comprising a thermocouple probe that is used for temperature sensing, wherein the probe is not necessarily be bonded to the heat block with an adhesive, but instead it is welded, soldered, or brazed to the heat block.

20. The thermal cycling device of claim 1, further comprising a non-contact temperature sensing device including at least a non-contact infrared temperature sensor, wherein the sensor is pointed towards the heat block in a position and orientation to produce an accurate temperature reading.

21. The thermal cycling device of claim 1, wherein temperature sensing is accomplished by utilizing the heaters as resistance temperature detectors (RTD).

22. The thermal cycling device of claim 1, wherein the device achieves cooling through natural gravity convection in lieu of cooling fans.
